(19) United States
(12) Patent Application Publication
(10) Pub. No.: US 2008/0270696 A1
(43) Pub. Date: Oct. 30, 2008

(54) VOLUME ASSIGNMENT MANAGEMENT DEVICE

(75) Inventors: Koichi MURAYAMA, Kawasaki (JP); Yuri HIRAIWA, Sagamihara (JP); Manabu OBANA, Kawasaki (JP); Nobuyuki OSAKI, Yokohama (JP)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD., Tokyo (JP)

(21) Appl. No.: 12/019,790

(22) Filed: Jan. 25, 2008

(30) Foreign Application Priority Data
Apr. 24, 2007 (JP) 2007-113679

(51) Int. Cl. G06F 1/32; G06F 12/00

(52) U.S. Cl. 711/114; 713/320; 711/E12.001

(57) ABSTRACT

The present invention is a management computer that determines, as the assignment source of a logical volume that is assigned in order to store predetermined data, a storage area of a RAID group including one or more disk drives among a plurality of disk drives provided in a storage system; and the CPU that executes the volume assignment module accepts a logical volume assignment request and, in cases where a logical volume assignment request is accepted, determines the RAID group which is the assignment source of the logical volume on the basis of the access trend assumed for the logical volume which is the subject of the assignment request.

### CROSS-REFERENCE TO PRIOR APPLICATION

This application relates to and claims the benefit of priority from Japanese Patent Application number 2007-113679, filed on Apr. 24, 2007, the entire disclosure of which is incorporated herein by reference.

### BACKGROUND

In recent years, the power consumption of storage systems has increased as these storage systems have increased in scale and attained higher functionality. In addition, there has also been a trend toward an increase in the number of storage systems held by a data center or the like as well as greater power consumption for the overall data center.

Hence, there has also been an increased interest in storage management that considers a reduction in power consumption in addition to the aspects of high functionality and high reliability as well as storage management cost reductions that are expected of a conventional storage system.

Technologies for solving the problem of reducing power consumption include a technology according to which the power consumption of a storage system is reduced as a result of a disk of the storage system being set to power saving mode or power OFF by the management computer in cases where there is no access to a disk within the storage system for a fixed time by the host, and canceling the power OFF when disk access takes place (See Japanese Application Laid Open No. No. 2005-157710, for example).

According to the above technology, the power consumption can be reduced by putting the disk in power saving mode in cases where there is no access to a disk for a fixed time.

However, unless there is access to the storage system for a fixed time, the disk is not set to power saving mode and a power saving effect is not obtained.

Hence, when volumes are assigned randomly from an available physical area of the storage system when a plurality of volumes are utilized, for example, the problem arises that the actual area of the volumes is scattered between a plurality of disks and, as a result, access to each disk takes place, the frequency with which power saving mode is assumed is low, and the power saving effect is then not sufficiently obtained.

In addition, as a result of volumes being assigned so that volumes of the same business are disposed on the same disk at the start of the operation, because the frequency of access to the volume drops when a predetermined time has elapsed after the operation starts, it is thought that the power saving function of the disk is operating. However, in cases where the volumes utilized for the business are extending by using the physical area of the same disk, even when the access frequency with respect to the physical area of the volume that is utilized first drops, due to the occurrence of a state where the access frequency with respect to the physical area of the volume that is subsequently extended remains high, there is also thought to be the possibility that the power saving function of the disk will not be exhibited even when a predetermined period has elapsed after the start of the operation.

In addition, in cases where the constitution is such that a certain disk is utilized for the backup of a plurality of business data, there is the possibility that the disk will be accessed intermittently and the power saving function will not operate as a result of the time taken to perform a backup of each business.

### SUMMARY

Therefore, the present invention was conceived in view of the above problem and an object thereof is to provide a technology that makes it possible to improve the power saving effect of the storage system.

In order to solve this problem, the present invention was conceived with an emphasis on the time taken to access a volume and the trend toward a reduction in the access frequency of the volume in the business so that the physical area constituting the logical volume assignment source is determined on the basis of the access trend.

The volume assignment management device according to a first aspect of the present invention is a volume assignment management device that determines, as the assignment source of a logical volume that is assigned in order to store predetermined data, a physical area including one or more storage media among a plurality of storage media provided in a storage system, comprising: a request acceptance unit that accepts an assignment request for the logical volume; and a physical area determination unit which, in cases where the assignment request for the logical volume is accepted, determines the physical area which is the assignment source of the logical volume on the basis of the access trend assumed for the logical volume which is the subject of the assignment request.

### BRIEF DESCRIPTION OF THE DRAWINGS

FIG. 1 shows a schematic constitution of the computer system according to a first embodiment of the present invention;

FIG. 2 shows an example of a disk management table according to the first embodiment of the present invention;

FIG. 3 shows the constitution of the storage management program according to the first embodiment of the present invention;

FIG. 4 shows an example of a volume assignment policy table according to the first embodiment of the present invention;

FIG. 5 shows an example of a resource group management table according to the first embodiment of the present invention;

FIG. 6 provides an overview of the processing according to the first embodiment of the present invention;

FIG. 7 shows volume assignment policy creation processing according to the first embodiment of the present invention;

FIG. 8 shows resource group creation processing according to the first embodiment of the present invention;

FIG. 9 shows volume assignment processing according to the first embodiment of the present invention;

FIG. 10 shows an example of a volume assignment policy table according to a first modified example of the present invention;

FIG. 11 shows an example of a resource group management table according to the first modified example of the present invention;

FIG. 12 shows the constitution of the storage management program according to a second embodiment of the present invention;

FIG. 13 shows an example of a volume assignment policy table according to the second embodiment of the present invention;

FIG. 14 shows an example of a resource group management table according to the second embodiment of the present invention;

FIG. 15 shows an example of an access frequency history table of a storage management program according to the second embodiment of the present invention;

FIG. 16 provides an overview of the processing according to the second embodiment of the present invention; and

FIG. 17 illustrates processing relating to the volume assignment according to the second embodiment of the present invention.

### DETAILED DESCRIPTION OF THE PREFERRED EMBODIMENT

Embodiments of the present invention will be described with reference to the drawings. The embodiments described herein below to not limit inventions within the scope of the claims and do not limit the requirement for all of the combinations of the features described in the embodiments to be the solving means of the invention.

### First Embodiment

(1) The System Constitution According to the First Embodiment

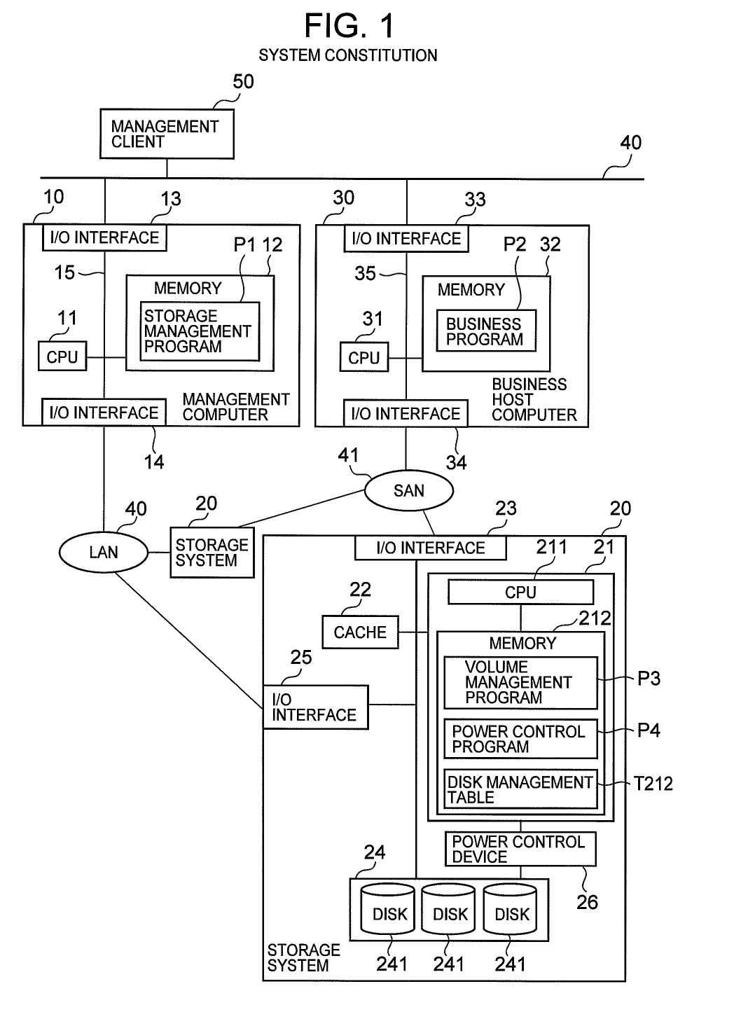

FIG. 1 shows the overall constitution of the computer system according to the first embodiment of the present invention.

This computer system comprises a management computer 10 as an example of the volume assignment management device, storage systems 20, a business host computer 30, and a management client 50. In this embodiment, the computer system has one management computer 10, two storage systems 20, one business host computer 30, and one management client 50 but may also have one or a plurality thereof. The management computer 10, storage system 20, business host computer 30, and management client 50 are connected to the management network 40 (LAN, for example). The business host computer 30 is connected to the storage system 20 via a data network 41 such as a SAN (Storage Area Network), for example. The SAN employs a communication protocol such as the Fiber channel or iSCSI protocol, for example.

The business host computer 30 executes business programs and backup programs and so forth such as a database management system (DBMS), writes the processing result to the storage system 20 or adopts the information resources stored in the storage system 20. The business host computer 30 comprises a CPU 31, memory 32, a front end I/O interface 33, and a rear end I/O interface 34. The CPU 31, memory 32, front end I/O interface 33 and rear end I/O interface 34 are mutually connected via a bus 35.

The management client 50 transmits a request to the management program P1 (described subsequently) which runs on the management computer 10 or receives the execution result of the management program P1 in accordance with a request from the user in order to execute a GUI or CLI and display the result for the user. The hardware constitution of the management client 50 is the same as that of the management computer 10 and a description thereof will therefore be omitted here.

The storage system 20 provides the business host computer 30 with a storage area and comprises a disk array controller 21, cache 22, data I/O interface 23, disk device 24, management I/O interface 25, and power control device 26. The disk array controller 21 is a control module that executes each type of control processing of the storage system 20 and comprises a CPU 211, a memory 212, and an I/O port (not illustrated). Cache 22 temporarily stores data to be written to the disk device 24 and data read from the disk drive 24. The disk device 24 is a disk array device which is afforded a RAID constitution (Redundant Arrays of Inexpensive Disks) by a plurality of magnetic hard disk drives (disk drives: one example of the storage media) 241. The disk device 24 provides one or a plurality of storage areas, in other words, logical units (LU: logical volumes) by means of a plurality of the hard disk drives 241 or provides one or a plurality of logical units by means of one hard disk drive 241. The power control device 26 controls the supply of power to the disk device 24 in accordance with control by the CPU 211.

The memory 212 stores a volume management program P3, a power control program P4, and a disk management table T212.

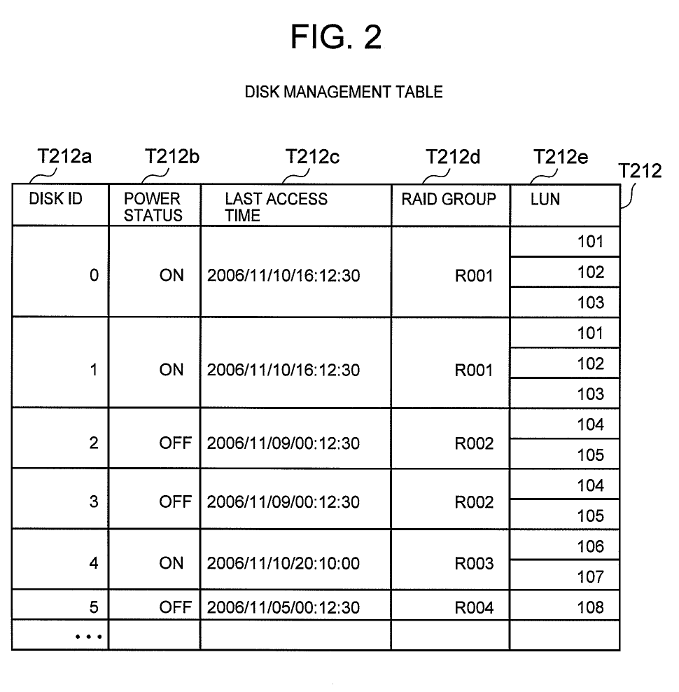

FIG. 2 shows an example of the disk management table according to the first embodiment of the present invention.

The disk management table T212 is a table for managing the status of the disk device 24 provided by the storage system 20 and is utilized by the volume management program P3 and power control program P4. The disk management table T212 contains a disk ID field T212a, power status field T212b, a last access time field T212c, a RAID group field T212d, and a LUN field T212e. The disk ID field T212a stores an ID (disk ID) for specifying a disk drive 241 that is stored in the disk device 24. The power status field T212b stores the power status of the disk drive 241. As the power status, “ON”, which indicates that the power has been turned on and “OFF”, which indicates that there is no supply of power, are set. The last access time field T212c stores the last access time for the disk drive 241. The RAID group number to which the disk drive 241 belongs is stored in the RAID group field T212d. The LUN field T212e stores an LU number that belongs to the RAID group.

Returning now to FIG. 1, the volume management program P3 is a program that causes the CPU 211 to execute various type of function supplied by the storage system 20 such as that of assigning the LU supplied by the disk device 24 to the business host computer 30 in accordance with a request from the management computer 10 or copying data of a certain LU to another LU supplied by the storage system 20 and so forth. The disk management table T212 is updated by the CPU 211 in cases where the status in which the LU is assigned is updated. For example, when the CPU 211 that executes the volume management program P3 receives a volume assignment request from the management computer 10, in cases where the volume is an LU contained in the RAID group “R001” and the LU number is “101”, “101” is added to the LUN field T212e of the record of disk ID “0” that constitutes the RAID group “R001” and to the LUN field T212e of disk ID “1” respectively.

The power control program P4 is a program that causes the CPU 211 to execute processing to control the power of the disk device 24 which involves monitoring the I/O with respect to the storage system 20 and, in cases where there is a disk drive 241 for which no I/O has been produced for a fixed period, executing a power saving function that stops the rotation of the disk drive 241 or reduces the power. For example, the CPU 211 that executes the power control program P4 monitors the I/O to the respective disk drives 241 of the disk device 24 and, in cases where no I/O is produced in the respective disk drives 241 for a predetermined period from the time of storage in the last access time field T212c of the disk management table T212, the power of the disk drive 241 is reduced by the power control device 26 and the power status field T212b of the corresponding record is updated to “OFF”. In addition, the CPU 211 that executes the power control program P4 starts up the disk drive 241 by means of the power control device 26 in cases where an I/O request for a disk drive in a power OFF status is produced and updates the power status field T212b of the corresponding record to “ON”. Furthermore, in cases where the disk drives 241 have a RAID constitution formed by a plurality of disk drives 241, the CPU 211 that executes the power control program P4 exercises synchronized ON/OFF control of the power of the other disk drives belonging to the same RAID group. Further, in cases where the devices associated with the disk, such as the CPU and power fan and other devices, for example, are also units that enable control of the power consumption, the CPU 211 that executes the power control program P4 may also exercise control so that these disk-related devices also make a synchronized transition to power saving mode.

The management computer 10 executes management for the storage system 20 such as, for example, the creation of volumes in the storage system 20, the assignment of volumes to the business host computer 30, and the replication and migration of volumes within the storage system 20 or between storage systems 20. The management computer 10 comprises a CPU 11, memory 12, front end I/O interface 13, and rear end I/O interface 14. The CPU 11, memory 12, front end I/O interface 13, and rear end I/O interface 14 are mutually connected via a bus 15. The CPU 11 is a computation processing device which executes various type of program and module stored in the memory 12. Here, as a result of the CPU 11 executing programs, a request acceptance unit, physical area determination unit, and assignment instruction transmission unit are constituted. The memory 12 is a co-called internal storage device that contains both a nonvolatile memory for storing various type of module of various programs and so forth and also a volatile memory for temporarily storing the computation processing result. In this embodiment, the memory 12 stores a storage management program P1. Here, the memory 12 corresponds to the policy storage unit.

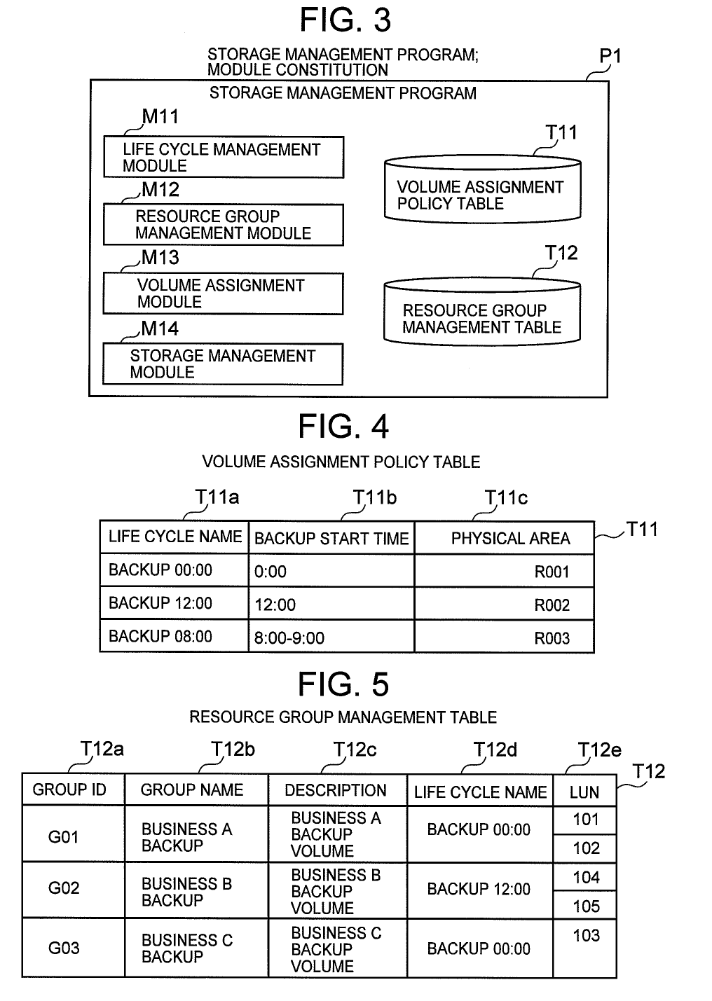

FIG. 3 shows the constitution of the storage management program according to the first embodiment of the present invention.

The storage management program P1 comprises a life cycle management module M11, a resource group management module M12, a volume assignment module M13, storage management module M14, a volume assignment policy table T11 which is an example of a policy storage unit, and a resource group management table T12. The storage management program P1 is a program for causing the CPU 11 to execute processing that provides a function related to the storage system 20 in coordination with the various programs in the storage system 20. For example, the CPU 11 that executes the storage management program P1 manages the constitution of the LU supplied by the storage system 20 and supplies functions related to changing the assignment and attributes of the LU as well as data copying between the LU and data migration.

The life cycle management module M11 is a module that causes the CPU 11 to execute the processing for managing life cycle definitions and for managing the associations between the life cycle definitions and the physical areas for generating the volumes. The life cycle definitions are definitions of information relating to access trends with respect to the volumes and include definitions for information relating to access time such as an increased time or reduced time for accessing a volume, for example. More specifically, for example, in the case of the volume used in the backup, the definition for information such as the start of a backup every day at 0:00 applies to the lifecycle definition. In addition, depending on the category of the business, in the case of a data volume for which it is assumed that the access frequency will drop in three months or a data volume for which it is assumed that the access frequency will drop in six months, information that the access frequency drops in three months and information that the access frequency drops in sixth months applies to the life cycle definitions. These definitions are managed by the volume assignment table T11.

The resource group management module M12 is a module that causes the CPU 11 to execute functions permitting the user to group and manage resources such as the volumes and business host computer 30 and so forth in optional units together with information constituting the business host computer 30 and storage system 20 which are management targets. For example, in cases where the LUN “101” and “102” are utilized as backup volumes for business A, the resource group management module M12 provides functions for grouping LUN “101” and “102” and managing same as a business A backup volume group. These data are stored in the resource group management table T12.

The volume assignment module M13 is a module that causes the CPU 11 to execute processing to issue a request to the storage system 20 such that, upon receipt of a volume assignment request from the user, the volume assignment module M13 references the resource group management table T11 and volume assignment table T12 to determine the RAID group (or disk) that corresponds to the access trend of the business data utilizing the volume and assigns a volume from this RAID group.

The storage management module M14 is a module that causes the CPU 11 to execute a storage management function for managing various management functions supplied by the storage system 20. The storage management functions include, for example, functions for management of the constitution of the storage resources such as the storage system 20 and volumes, control and monitoring functions for data replication, and data migration.

The volume assignment policy table T11 is a table for managing life cycle definitions and physical areas where volumes corresponding with the life cycle definitions should be generated, that is, volumes corresponding with the life cycle definitions should be assigned. Here, a physical area may be a storage area of one disk drive 241, a storage area of a RAID group constituted by a plurality of disk drives 241, or a storage area of any storage system among a plurality of storage systems 20, for example, and, in cases where a plurality of storage systems 20 are provided in each of a plurality of sites, a physical area may also be a storage area of a storage system 20 of any site, in short, a storage area for generating a volume that corresponds with the life cycle definition.

FIG. 4 shows an example of a volume assignment policy table according to the first embodiment of the present invention.

The volume assignment policy table T11 contains a life cycle name field T11a, a backup start time field T11b, and a physical area field T11c. The life cycle name which is a name for uniquely identifying a life cycle is stored in the life cycle name field T11a. The backup start time indicating the start time of the backup is stored in the backup start time field T11b. The backup start time may be a specified time or a time within a range of times such as 8:00 to 9:00. In this case, this signifies the fact that the start of a backup takes place from 8:00 to 9:00. In this embodiment, because volume assignment that follows a backup schedule is taken by way of an example, the backup start time is employed as a table attribute but the attribute is not limited to the backup start time and may be any information that makes it possible to judge the access frequency in time units.

The physical area field T11c stores identification information indicating the physical area where the volume for the business or application in accordance with the corresponding life cycle is generated. In this embodiment, the RAID group number is stored in the physical area field T11c but is not limited thereto and may instead be an attribute value of a unit of a physical area enabling the ON/OFF control by the power saving function. The attribute value used may also be the disk ID, storage system ID, storage pool ID or the like, for example.

For the first record shown in FIG. 4, the life cycle of the business of starting a backup every day at 0:00 is defined by the life cycle name “backup 00:00” and signifies the fact that the volume corresponding to the life cycle should be assigned from RAID group “R001”.

The resource group management table T12 is a table for managing the association between the definition of resource groups and the storage resources belonging to the resource group.

FIG. 5 shows an example of a resource group management table according to the first embodiment of the present invention.

The resource group management table T12 contains a group ID field T12a, a group name field T12b, a description field T12c, a life cycle name field T12d, and a LUN field T12e. The group ID field T12a stores a group ID which is an ID for uniquely identifying a resource group. Here, the resource groups are resources assumed to have same the access trend which, here, are groups in which volumes have been collected. In this embodiment, for example, the resource groups are groups of volumes utilized in backups for the same business. The group name field T12b stores the group names which are the names of resource groups of the corresponding records. The description field T12c stores a description of the corresponding resource group. The life cycle name field T12d stores the life cycle name representing the life cycle of the volume contained in the corresponding resource group. The life cycle name corresponds to the life cycle name of the life cycle name field T11a of the volume assignment policy table T11. The LUN field T12e stores the LU numbers (LUN) of the volumes belonging to the corresponding resource groups. The LUN of the LUN field T12e stores the LUN corresponding to the disk management table T212 held by the storage system 20.

The first record shown in FIG. 5 signifies that the resource group with the group name “business A backup” is constituted by the LUN “101” and “102” that store the backup data of business A and that a backup is executed in accordance with the defined life cycle (managed by the volume assignment policy table T11) with the life cycle name “backup 00:00”. In other words, the record signifies that the LUN “101” and “102” are volumes for which access occurs from 0:00 every day until the backup ends.

(2) The Operation According to the First Embodiment

The operation according to the first embodiment will be described next.

In the computer system of this embodiment, the volumes assigned to the respective business host computers 30 form copy pairs and the backup volumes (secondary volumes) of each of these volumes are grouped for each business. Further, a backup start time is associated in the form of a life cycle definition with each RAID group. Here, an overview of processing that takes, by way of example, a case where the backup volume of the volume assigned to a certain business host computer 30 is newly assigned will be described.

In a case where such an assignment request is occurred, the CPU 11 that executes the management program of the management computer 10 performs processing to assign a backup start time for the business constituting the volume assignment object and a backup volume from the RAID group associated with a backup start time that matches the backup start time. As a result of this processing, because volumes whose backup start times match or are close, that is, volumes for which the times at which access occurs coincide or are close are collected in the same RAID group (or disk drive), the times at which the disk drives 241 operate are collected. Hence, the power saving function of the disk drives 241 is executed and a long power OFF status can be expected, whereby the effects of the power saving function of the storage system 20 can be improved.

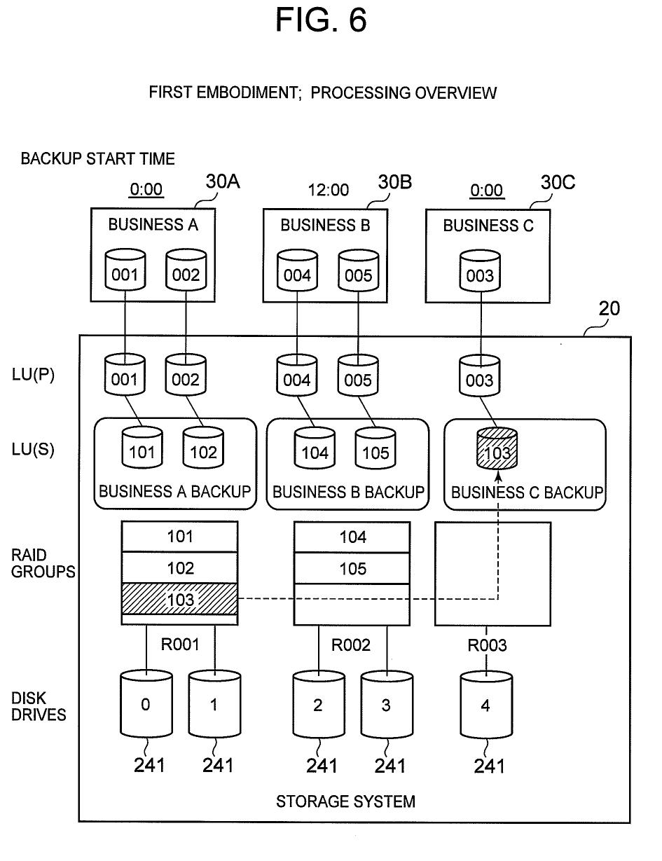

FIG. 6 provides an overview of the processing according to the first embodiment of the present invention.

For example, in a constitution in which the business host computer 30A that is utilized in a business A, a business host computer 30B that is utilized in a business B, and a business host computer 30C that is utilized in a business C share a single storage system 20 as shown in FIG. 6, the LUN “001” and “002” are assigned to business A as copy pair primary volumes while LUN “101” and “102” are assigned to business A as secondary volumes. LUN “101” and “102” belong to the business A backup group. The LUN “004” and “005” are assigned to business B as copy pair primary volumes while the LUN “104” and “105” are assigned to business B as secondary volumes. The LUN “104” and “105” belong to the business B backup group. LUN “003” are assigned as copy pair primary volumes to business C.

Here, an overview of processing that takes, by way of example, a case where the backup volume LUN “103” of business C is newly assigned to the business host computer 30C will be described.

In cases where an assignment request to newly assign the backup volume LUN “103” of business C is produced, the CPU 11 that executes the storage management program P1 of the management computer 10 performs processing to assign a volume from the same RAID group “R001” as business A that has the same backup time as the backup time of business C. As a result, disks for which access occurs at “0:00” can be collected in RAID group “R001”. Hence, because the times at which the disk drives 241 operate can be collected, the power saving function is executed for the disk drives 241 and a long POWER OFF status can effectively be expected so that the power saving effect improves in comparison with a case where volumes are assigned in a random manner.

The processing according to the first embodiment will be described in detail next.

The computer system of this embodiment executes volume assignment policy creation processing for defining a life cycle of data such as a backup schedule that are stored in a volume, resource group creation processing for grouping the respective volumes for each business to establish a life cycle by and volume assignment processing in which the CPU 11 executing the storage management program P1 assigns volumes from a suitable physical area in accordance with the defined life cycle definition.

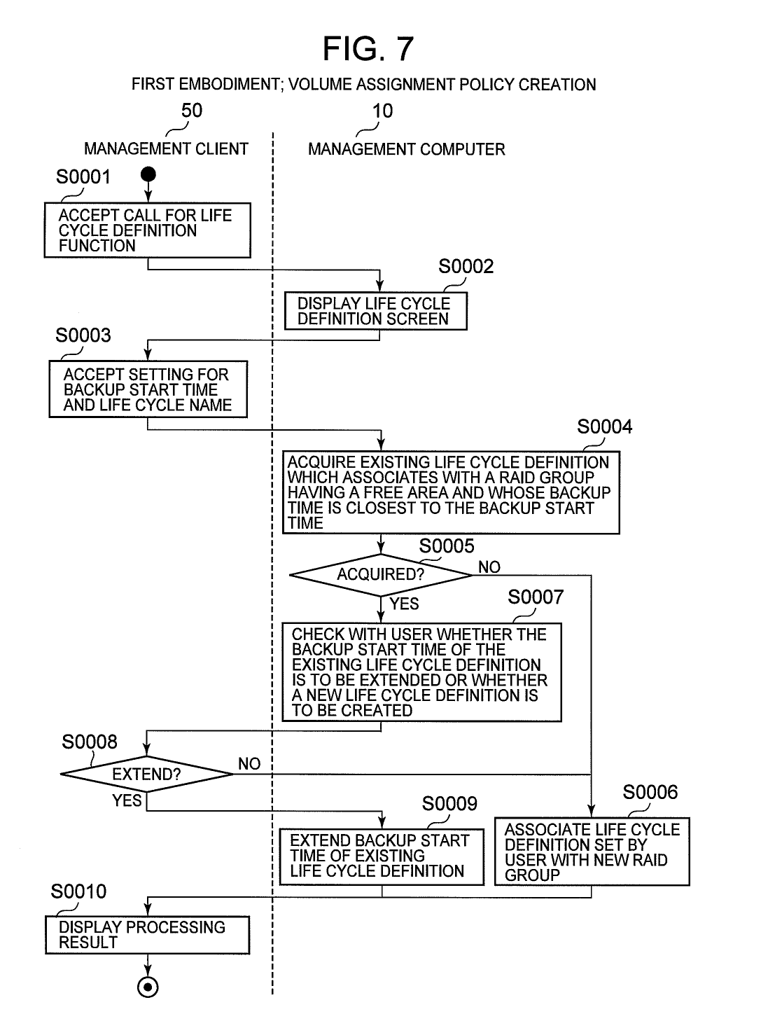

FIG. 7 shows volume assignment policy creation processing according to the first embodiment of the present invention.

In the volume assignment policy creation processing, the user determines the RAID group that corresponds with the life cycle definition on the basis of the life cycle definition set by the user and registers the life cycle definition and RAID group information in the volume assignment policy table T11. The specific operation will be described hereinbelow.

When the management client 50 accepts a request from the user to call up the life cycle definition function with respect to the storage management program P1 in the management computer 10 (step S0001), the management client 50 transmits the request to the management computer 10.

In the management computer 10, the CPU 11 that executes the storage management program P1 displays a life cycle definition screen on the management client 50 in accordance with the request (step S0002). The management client 50 accepts settings for the life cycle name and backup start time in accordance with an input to the life cycle definition screen made by the user (step S0003) and transmits the accepted set content to the management computer 10. In the management computer 10, the CPU 11, which accepts the set content and executes the life cycle management module M11 of the storage management program P1 references the backup start time field T11b of the volume assignment policy table T11 and acquires a life cycle definition in which the physical area denoted by the physical area field T11c has a free area to which a new volume can be assigned and which is a life cycle definition according to which the backup start time of the accepted set content and the backup start time within a predetermined time (within one hour, for example) are set (step S0004). Further, whether there is a free area can be grasped by acquiring information on free areas of the physical areas managed by the storage system 20.

As a result, in cases where has not been possible to acquire a life cycle definition (step S0005, NO), the CPU 11 creates a new record that associates the life cycle definition set by the user and new RAID group that has not been associated with the existing life cycle definition and stores the associations in the volume assignment policy table T11 (step: S0006).

However, in cases where a life cycle definition has been obtained (step S0005, YES), the CPU 11 issues an inquiry to the user via the management client 50 to inquire whether to extend the backup start time of the life cycle definition or establish a new assignment policy (step S0007). In cases where a choice to not extend the backup start time is received from the user (step S0008:NO), the management client 50 transmits the result to the management computer 10. Thereafter, the CPU 11 of the management computer 10 stores a new record that associates the life cycle definition set by the user and new RAID group that has not been associated with the existing life cycle definition in the volume assignment policy table T11 (step: S0006).

However, upon receipt of a choice to extend the backup start time from the user (step S0008, YES), the management client 50 transmits the result to the management computer 10. Thereafter, the CPU 11 of the management computer 10 extends the backup start time of the existing life cycle definition and updates the volume assignment policy table T11 (step S0009). For example, in cases where the backup start time of the existing life cycle definition is “8:00” and the backup start time set by the user is “9:00”, when the choice to extend the backup start time is received from the user, the CPU 11 updates the backup start time of the existing life cycle definition to “8:00 to 9:00”. The CPU 11, which executes the life cycle management module M11 when the processing to update the volume assignment policy table T11 ends, reports the processing result to the management client 50. As a result, the management client 50 displays the processing result (step S0010). As a result of the above processing, an association between the volume life cycle definition and the RAID group supplying the physical area is defined.

The resource group creation processing that groups the volumes for each program that utilizes the business units and volumes will be described in detail next.

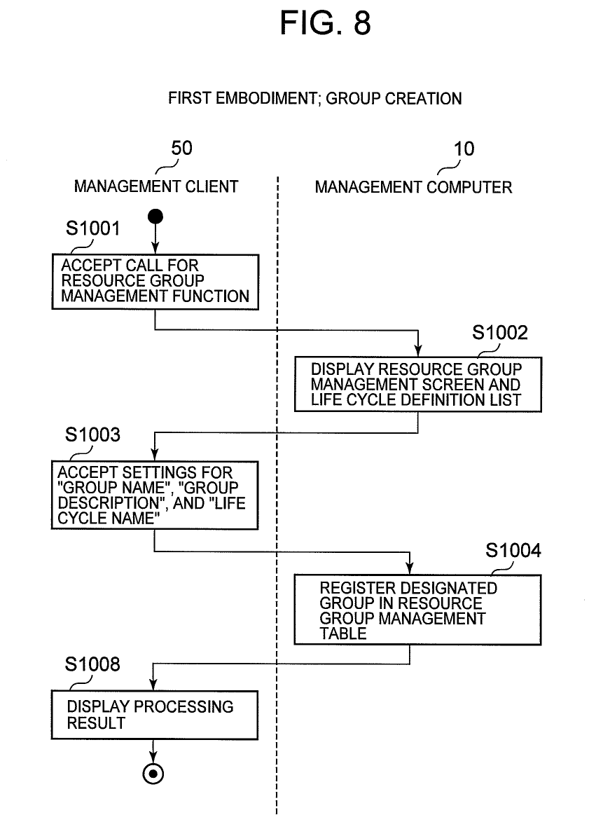

FIG. 8 shows the resource group creation processing according to the first embodiment of the present invention.

In the resource group creation processing, the association between the resource group definition set by the user and the life cycle for the data contained in the resource group is registered in the resource group management table T12.

The management client 50 receives a request from the user to call up a resource group management function with respect to the storage management program P1 in the management computer 10 (step S1001) and the management client 50 transmits this request to the management computer 10. In the management computer 10, the CPU 11, which executes resource group management module M12 of the storage management program P1, causes the management client 50 to display a resource group management screen and a list of registered life cycles in accordance with a request from the user (step S1002). The life cycle list can be displayed on the basis of the information acquired from the volume assignment policy table T11. The management client 50 accepts the group designations “group name”, “group description”, “life cycle name” in accordance with inputs to the resource group management screen made by the user (step S1003) and transmits the content of the accepted group to the management computer 10. For example, in cases where are source group form an aging volumes for storing business A backup data is created, the group name “business A backup” and the description “business A backup volume” are accepted and, if the backup schedule for business A starts at 0:00 every day, a selection designation is accepted with “backup 00:00” taken as the life cycle name which is a life cycle for which the backup start time from the life cycle definition list is 0:00. Further, in cases where a volume already exists, a designation of the LUN of the corresponding volume may also be accepted.

In the management computer 10, the CPU 11 that executes the resource group management module M12 acquires the set content of the group, generates a unique group ID, and registers a new record that contains the group ID and the acquired set content of the group in the resource group management table T12 (S1004). Further, whereas, in cases where a LUN is not contained in the set content, the LUN field T12e of the record is in a free state, when a LUN is contained, the LUN is stored in the LUN field T12e of the record. When registration in the resource group management table T12 ends, the CPU 11 that executes the resource group management module M12 reports the processing result to the management client 50. As a result, the processing result is displayed on the management client 50 (step S1008). Further, in cases where a plurality of resource groups are created, the above processing is repeated. After the above processing ends, the user is able to move on to the work of assigning a new volume.

Volume assignment processing which determines the physical areas of the volumes when volumes are assigned for the volume of the business host computer and the volume of the copy pair will be described next. The volume assignment processing can also be applied when assigning a migration destination volume during volume migration, for example. In this case, the physical area of the migration destination volume may be determined in accordance with the life cycle definition for the business associated with the migration source volume.

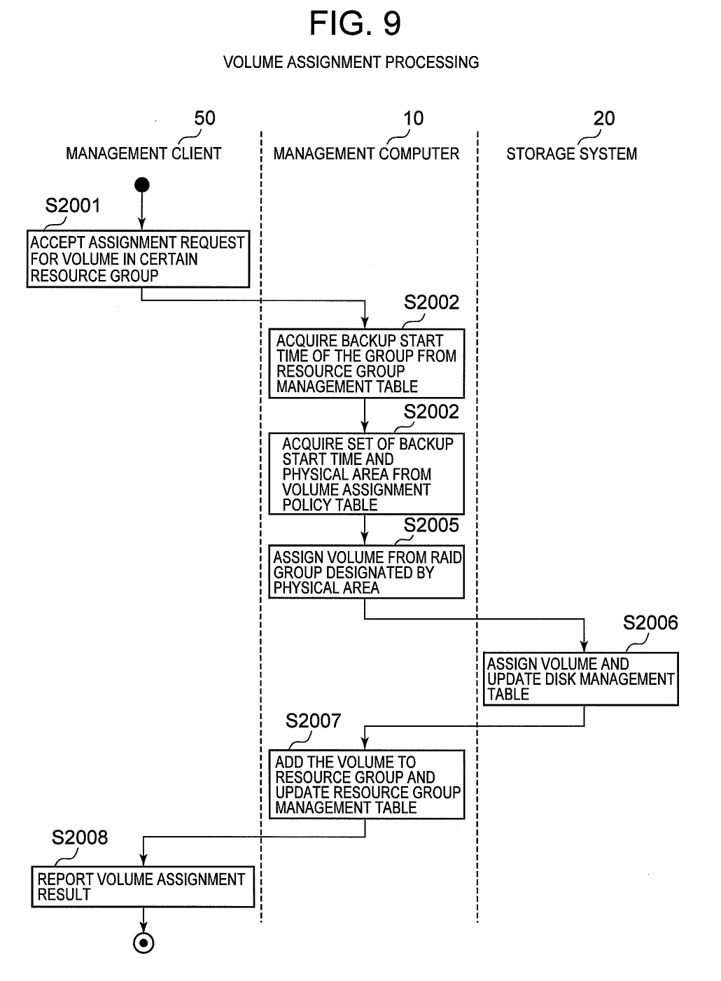

FIG. 9 shows the volume assignment processing according to the first embodiment of the present invention.

The management client 50 accepts a designation of the resource group to which the new volume is added and a designation requesting the assignment of a new volume in the resource group (step S1001). Here, the management client 50 accordingly accepts other setting information that is required for volume assignment such as, for example, the setting of the assigned LUN and volume size. Thereupon, the user is able to easily designate the assignment of a volume without identifying the physical constitution with which the power saving function of the storage system 20 is effective. Thereafter, the management client 50 transmits a volume assignment request that contains the designation of the resource group and other information required for volume assignment to the management computer 10.

In the management computer 10, the CPU 11, which executes the volume assignment module M13 of the storage management program P1 references the life cycle name field T12c of the resource group management table T12 corresponding with the designated resource group, acquires the life cycle name of the resource group (step S2002), and acquires a physical area for storing the data of the volume on the basis of the life cycle and the backup start time corresponding with the life cycle name from the volume assignment policy table T11 (step S2003). The CPU 11, which executes the volume assignment module M13, issues a request to the CPU 211 that executes the volume management program P3 of the storage system 20 to assign a volume in accordance with the setting information set by the user from the RAID group corresponding with the acquired physical area (step S2005). The CPU 211, which executes the volume management program P3 that acquires this request, assigns a volume in accordance with the setting information and updates the disk management table T212 (step S2006). When the volume assignment is successful, the CPU 11 that executes the volume assignment module M13 adds the LUN of the new volume thus assigned to the LUN field T12e of the record corresponding with the resource group of the resource group management table T12 (step S2007). When the above processing is complete, the CPU 11 that executes the volume assignment module M13 reports the volume assignment result to the management client 50. As a result, the volume assignment result is displayed by the management client 50 (step S2008).

As a result of the above processing, because a volume has been assigned so that data whose access trends match are contained in the same RAID group, the power saving function of the disk device 24 provided by the storage system 20 can be made to operate effectively.

A modified example of this embodiment will be described next.

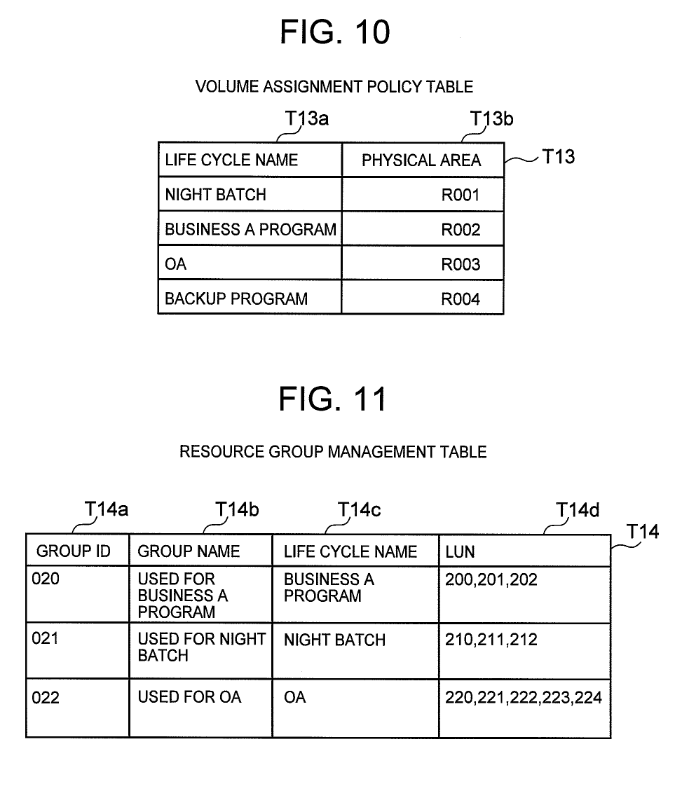

In the above embodiment, the backup start time field T11b is provided in the volume assignment policy table T11 and backup volumes with the same backup start time are disposed in the same RAID group (or disk). However, the present invention is not limited to such an arrangement. In cases where the form of use of the program that utilizes a volume, for example, where the access trend is known as ‘night batch’, the volume assignment policy table T13 shown in FIG. 10 may be used.

FIG. 10 shows an example of a volume assignment policy table according to the first modified example of the present invention.

The volume assignment policy table T13 contains a life cycle name field T13a and a physical area field T13b. The life cycle name field T13a stores, as the life cycle name, a program name such as ‘night batch’, for example, a business A program, an OA, or a backup program or the like. The physical area field T13b stores information identifying the physical area in which the volumes for the business or application that is operating in accordance with the corresponding life cycle, are to be generated.

According to the volume assignment policy table T13, it is possible to grasp a disparity in the access trends from the life cycle name stored in the life cycle name field T13a. If the life cycle name is night batch, for example, it is clear that volumes associated with the night batch are mainly accessed at night and, if the life cycle name is OA, it can be understood that OA volumes are often accessed during normal working hours. As a result, a usage time-related field need not be provided, which in turn makes it possible to reduce the data amount.

An example of the resource group management table in the case of the volume assignment policy table T13 shown in FIG. 10 will now be described.

FIG. 11 shows an example of the resource group management table according to the first modified example of the present invention.

The resource group management table T14 comprises a group ID field T14a, a group name field T14b, a life cycle name field T14c, and a LUN field T14d. Group IDs are stored in the group ID field T14a. The group name field T14b stores the type of business program as the group name. The life cycle name field T14c stores the program type name as the life cycle name. The LUN field T14d stores the LUN(s) of the volumes belonging to the corresponding resource group.

When a volume is assigned in cases where such a resource group management table T14 is prepared, the management client 50 accepts a designation of the type of program using the assigned volume from the user. In this case, the CPU 11 of the management computer 10 accepts the program type from the management client 50, acquires the life cycle name corresponding with the program type from the resource group management table T14, and acquires the physical area corresponding with the life cycle name from the volume assignment policy table T13, such that a volume is assigned from the physical area.

### Second Embodiment

The second embodiment of the present invention will be described next. The differences from the first embodiment will be mainly described and a description of points in common with the first embodiment will be omitted or simplified.

In the second embodiment, the life cycle definitions applied by the user to each business are not set beforehand. Rather, the applied life cycle definitions are specified from the history of the access frequencies of the existing volumes and the physical area of the new volume is determined in accordance with the result of this specification. This embodiment is effective in cases where it is hard to clearly pre-define the access trend for a given volume.

The computer system according to the second embodiment is constituted by providing the computer system of the first embodiment shown in FIG. 1 with a storage management program P5 in lieu of the storage management program P1.

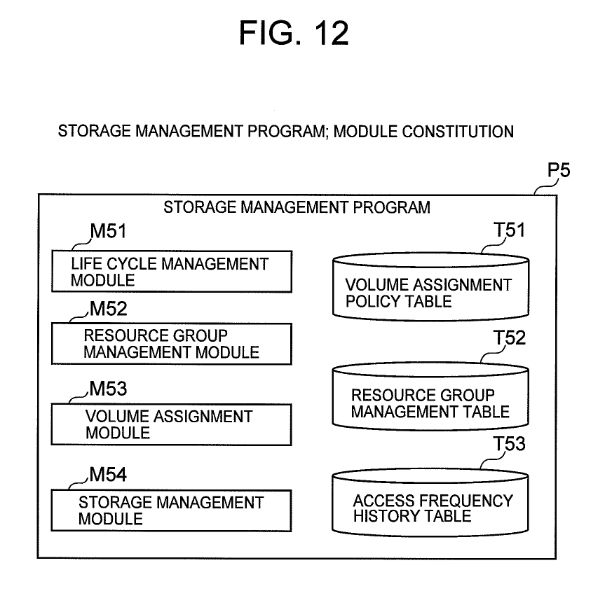

FIG. 12 shows the constitution of the storage management program according to the second embodiment of the present invention.

The storage management program P5 comprises a life cycle management module M51, a resource group management module M52, a volume assignment module M53, a storage management module M54, a volume assignment policy table T51, a resource group management table T52, and an access frequency history table T53. The storage management program P5 is a program that causes the CPU 11 to execute processing to provide functions related to the storage system 20 in coordination with various type of program in the storage system 20. For example, the CPU 11, which executes the storage management program P5, manages the constitution of the LU provided by the storage system 20 and provides functions related to changing the assignment and attributes of the LU as well as data copying between the LU and data migration.

The life cycle management module M51 is a module that causes the CPU 11 to execute the processing for managing life cycle definitions and for managing the associations between the life cycle definitions and the volumes. The life cycle definitions are definitions of information relating to access trends with respect to the volumes and include definitions relating to times at which access to a volume drops, for example. More specifically, for example, there are definitions reducing access in July of 2006 and definitions of reduced access in September of 2006. These definitions are managed by the volume assignment policy table T51.

The resource group management module M52 is a module that causes the CPU 11 to execute functions permitting the user to group and manage resources such as the volumes and business host computer 30 and so forth in optional units together with information constituting the business host computer 30 and storage system 20 which are management targets. For example, in cases where the LUN “101” and “102” are utilized as business A volumes, the resource group management module M52 provides functions for grouping LUN “101” and “102” and managing same as a business A volume group. These data are stored in the resource group management table T52.

Upon accepting the volume assignment request from the user, the volume assignment module M53 references the resource group management table T52 and access frequency history management table T53 to determine the access frequency reduction time for the resource group to which the new volume belongs, determines the RAID group (or disk) for which the access trend drops at the same time as or close to the access frequency reduction time by referencing the volume assignment policy table T51, and issues a request to the storage system 20 to assign a volume from the RAID group.

The storage management module M54 is a module that causes the CPU 11 to execute the storage management function for managing the various management functions provided by the storage system 20. The storage management functions include, for example, a function for managing the constitution of the storage resources such as the storage system 20 and volumes and so forth, a function for controlling and monitoring the data replication, and a data migration function and so forth. In this embodiment, the storage management module M54 causes the CPU 11 to execute processing to acquire information on accessing the respective LU of the storage system 20 and manage the history of the access frequencies for the respective LU. The access frequency history is managed by the access frequency history table T53.

The volume assignment policy table T51 is a table for managing the associations between the life cycle definitions and the physical areas in which the volumes corresponding with the life cycle definitions are to be generated. Here, a physical area may be a storage area of one disk drive 241, a storage area of a RAID group constituted by a plurality of disk drives 241, or a storage area of any storage system among a plurality of storage systems 20, for example, and, in cases where a plurality of storage systems 20 are provided in each of a plurality of sites, a physical area may also be a storage area of a storage system 20 of any site, in short, a storage area for generating a volume that corresponds with the life cycle definition.

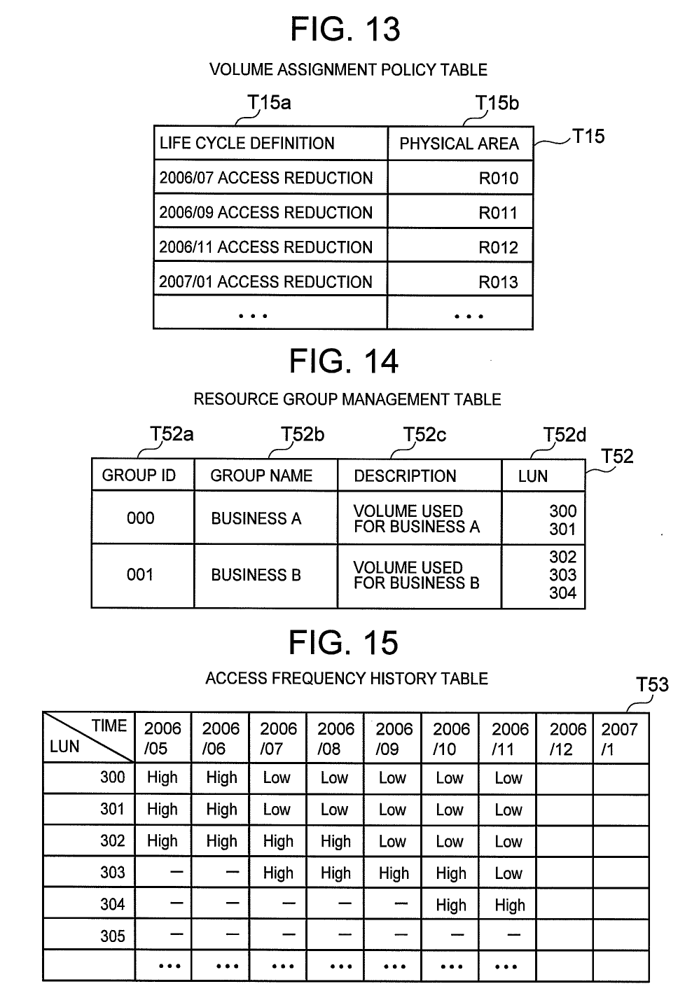

FIG. 13 shows an example of a volume assignment policy table according to the second embodiment of the present invention.

The volume assignment policy table T51 contains a life cycle definition field T51a and a physical area field T51b. The life cycle definition field T51a stores a life cycle definition that indicates the reduction time for the access frequency with respect to a volume(s). The life cycle definition field T51a stores a “2006/07 access reduction” as the life cycle definition for a volume for which access in July of 2006 is expected to drop, for example. For example, a life cycle definition indicating the access frequency reduction time every two months is stored for a plurality of years in the life cycle definition field T51a. The physical area field T51b stores identification information indicating the physical area in which the volumes that conforms to the corresponding life cycle definition are to be generated. In this embodiment, a RAID group number is stored in the physical area field T51b. However, in the case of physical areas units permitting control of the ON/OFF of the power saving function, other attribute values may also be used. Examples of other attribute values include the disk ID, storage system ID, and a storage pool ID for handing a plurality of volumes virtually as one volume. The volume assignment policy table T51 is updated by the life cycle management module M51 of the storage management program P5.

FIG. 14 shows an example of a resource group management table according to the second embodiment of the present invention.

The resource group management table T52 comprises a group ID field T52a, a group name field T52b, a description field T52c, and a LUN field T52d. The group ID field T52a stores a group ID which is an ID for uniquely identifying a resource group. Here, the resource group is a group of volumes for which it is assumed that the trend toward an access frequency reduction is the same. In this embodiment, if the business is the same, the same trend toward an access frequency reduction is assumed and, therefore, volumes are grouped by taking businesses as units. If there is the same trend toward an access frequency reduction, the resource group is not limited to volumes for which businesses are taken as the units. The group name field T52b stores the group name which is the name of the resource group of the corresponding record. The description field T52c stores a description for the corresponding resource group. The LUN field T52d stores the LUNs of volumes that belong to the corresponding resource group. The resource group management table T52 is updated by the resource group management module M52.

FIG. 15 shows an example of an access frequency history table of a storage management program according to the second embodiment of the present invention.

The access frequency history table T53 is a table that holds the access frequency history for each LUN provided by the storage system 20. The access frequency history table T53 is updated by the performance monitoring function implemented by the CPU 11 that executes the storage management module M54, whereby the data are accumulated.

The access frequency history table T53 stores information on the access frequency for each predetermined period for a plurality of LUNs. In this embodiment, information stored as access frequency information is not the actual access count but, rather, information indicating the level of the access frequency. More specifically, information indicating whether the possibility that the power saving function of the disk drive 241 of the storage system 20 will operate is at a certain level is stored. For example, in cases where the access frequency is at a level where the power saving function will not operate, “High” is stored and, in cases where the access frequency drops to the level where the power saving function will operate, “Low” is stored. When a corresponding volume has not been assigned, “−” is stored. For example, in cases where a condition such as the condition that access will not occur for one hour or more is set as the condition for operating the power saving function of the disk drive 241, in other words, as the condition for reducing the power of the disk drive 241, “High” is stored in the column “2006/05” for a volume that was accessed an average of twenty-five times or more in one day in May of 2006.

The operation of the second embodiment will be described next.

In the computer system of this embodiment, volumes assigned to the respective business host computers 30 are grouped for each business. The times at which the access frequency drops are then associated with each RAID group as the life cycle definition.

Here, an overview of processing that takes, by way of example, a case where a new volume is assigned to a certain business host computer 30 will be provided. In cases where an assignment request is made, the CPU 11, which executes the storage management program P5 of the management computer 10, determines the time at which the access frequency of the newly assigned volume is expected to drop from the access frequency history for the existing volumes of the business and performs processing to assign a volume from the RAID group associated with the life cycle definition for which this time and the time at which the access frequency drops coincide. As a result of this processing, because volumes for which the access frequencies drop in the same time are gathered in the same RAID group, when a predetermined time has elapsed, the power saving function operates because the access frequencies for the disk drives 241 belonging to the same RAID group drop and a power OFF state is assumed, whereby the efficiency of the power saving function of the storage system 20 can be improved from a long term perspective.

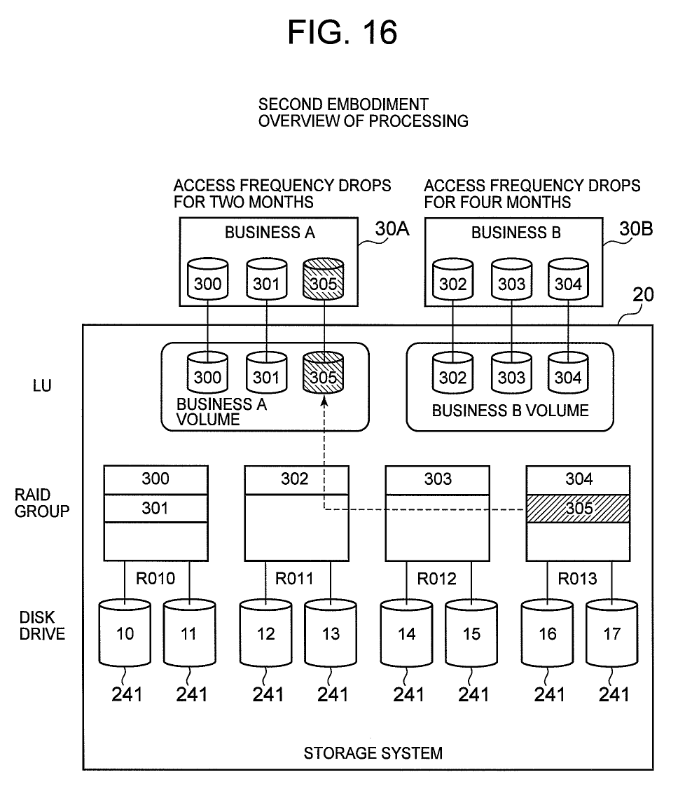

FIG. 16 provides an overview of the processing according to the second embodiment of the present invention.

In a case where the LUN “305” is assigned by newly expanding the volume of business A, when the fact that the access frequency drops over a two month period for business A is detected from the previous access frequency information and the fact that the access frequency drops every four months for business B is detected, processing is performed to assign a volume from a RAID group for which the times at which the access frequency of the volumes of assigned business A drops (in two months' time) coincide, that is, from RAID group “R013” to which the volume “304” assigned to business B two months earlier belongs. Hence, in two months' later, a drop in the access frequency with respect to volume “304” of business B occurs and the access frequency of the new volume “305” of the business A is expected to drop at the same time. Hence, a power saving effect for the respective disks of the RAID group “R013” can also be expected.

The processing according to the second embodiment will be described next.

In the computer system of the embodiment, the CPU 11, which executes the volume assignment policy creation processing for creating the life cycle definition, the resource group creation processing for performing grouping for each business, and the storage management program P5, executes volume assignment processing that assigns a volume from a suitable physical area in accordance with the defined life cycle definition. Further, the data stored in the volume assignment policy table T51 and resource group management table T52 as a result of the volume assignment policy creation processing and the resource group creation processing differ from the stored data as a result of the processing of the first embodiment shown in FIGS. 7 and 8. However, the overall flow is substantially the same and a description thereof will therefore be omitted here.

Volume assignment processing for determining the physical area of the volume when assigning the new volume will be described next. The volume assignment processing can also be applied when a migration destination volume is assigned during volume migration, for example. Further, in this case, the physical area of the migration destination volume may also be determined in accordance with the life cycle definition of the business associated with the migration source volume.

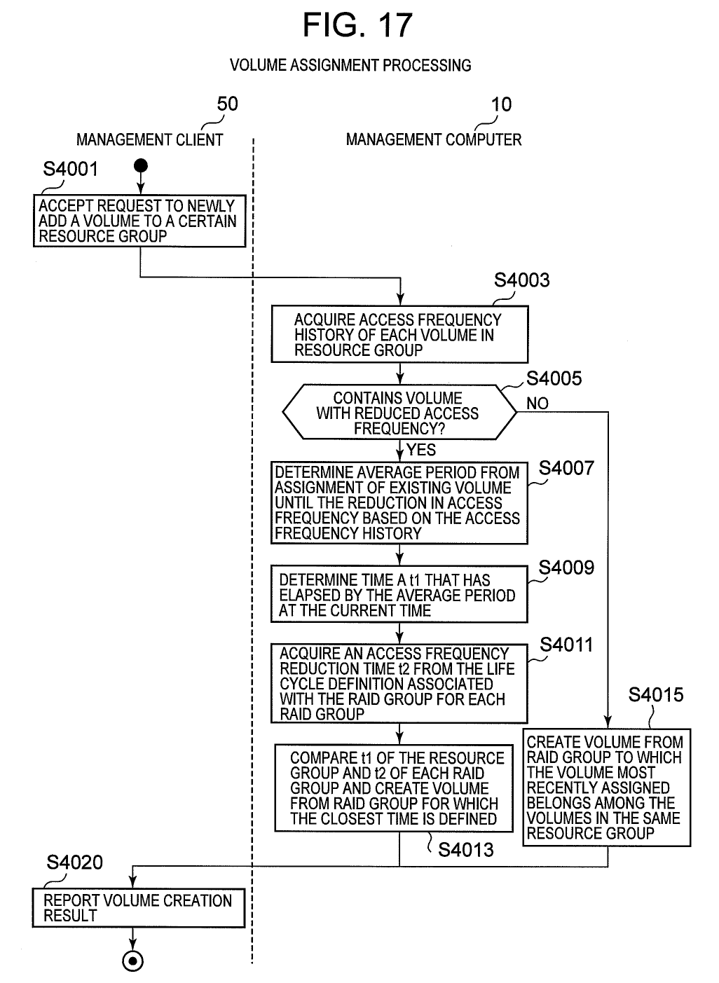

FIG. 17 shows the volume assignment processing according to the second embodiment of the present invention.

The management client 50 accepts a designation of a resource group (business, for example) to which the new volume is added and a designation of the new volume assignment request of the resource group from the user (step S4001). Thereupon, the management client 50 accordingly accepts other setting information that is required for volume assignment such as, for example, the setting of the assigned LUN and volume size. Thereupon, the user is able to easily designate the assignment of a volume without identifying the physical constitution with which the power saving function of the storage system 20 is effective. Thereafter, the management client 50 transmits a volume assignment request that contains the designation of the resource group and other setting information required for volume assignment to the management computer 10.

In the management computer 10, the CPU 11, which executes the volume assignment module M53 of the storage management program P5, acquires the access frequency history of each volume in the resource group from the access frequency history table T53 (step S4003).

Thereafter, the CPU 11 judges whether a volume for which the access frequency drops is contained among the volumes in the resource group (a LUN for which the corresponding access frequency is currently “Low” in FIG. 15).

As a result, in cases where a volume for which the access frequency drops is not contained in the same resource group (step S4005, NO), a volume is created from the RAID group to which the volume belongs which is considered to have an access frequency that matches or is close to the access frequency of the most recently assigned volume among the volumes in the same resource group (step S4015). In other words, a request is issued to the CPU 211 that executes the volume management program P3 of the storage system 20 to assign a volume in accordance with the setting information set by the user from the RAID group. As a result, the CPU 211, which executes the volume management program P3 that acquired the request, assigns a volume in accordance with the setting information and updates the disk management table T212. When the volume assignment is successful, the CPU 11, which executes the volume assignment module M53, adds the LUN of the assigned new volume to the LUN field T52d of the record corresponding with the resource group of the resource group management table T52.

However, in cases where a volume for which the access frequency drops is contained in the same resource group (step S4005, YES), the CPU 11, which executes the volume assignment module M53, determines the period (time) from the assignment until the access frequency reduction for each of the existing volumes in the resource group on the basis of the access frequency history of the access frequency history table T53, calculates the average period following assignment of each volume in the same resource group until the access frequency drops (step S4007), adds the average period to the current time, and determines the expected time at which the access frequency of the newly assigned volume is expected to drop (step S4009). Thereafter, the CPU 11, which executes the volume assignment module M53, acquires a list of times at which the access frequency drops from the list of life cycle definitions that are associated with the RAID group from the volume assignment policy table T51 in the respective RAID groups belonging to the storage system 20 (step S4011).

Thereafter, the CPU 11, which executes the volume assignment module M53, compares the expected access frequency reduction time which was determined from the resource group of the business unit found in step S4009 with the expected access frequency reduction time of each RAID group found in step S4011 and creates a volume from a physical area of the RAID group with the closest expected access frequency reduction time (step S4013). In other words, a request is sent to the CPU 211, which executes the volume management program P3 of the storage system 20 to assign a volume in accordance with the setting information set by the user from the RAID group with the closest expected access frequency reduction time. As a result, having acquired the request, the CPU 211, which executes the volume management program P3, assigns a volume in accordance with the setting information and updates the disk management table T212. When the volume assignment is successful, the CPU 11, which executes the volume assignment module M53, adds the LUN of the assigned new volume to the LUN field T52d of the record corresponding with the resource group of the resource group management table T52.

When the processing of step S4013 or step S4015 ends, the CPU 11 that executes the volume assignment module M53 reports the volume assignment result to the management client 50. As a result, the volume assignment result is displayed by the management client 50 (step S4020).

As a result of the above processing, because volumes assumed to have matching access frequency reduction times can be assigned from the same RAID group, the power saving function of the disk device 24 provided by the storage system 20 can be made to operate effectively.

According to the embodiment hereinabove, when a volume is assigned to a certain business or a certain application, by assigning a volume from a disk that stores data for which the period in which access occurs and the access reduction period match in accordance with the access trend of the volume utilized by the business and the access trend of the application that utilizes the volume, data with matching access trends can be collected in the same disk and the power saving function provided by the storage device can be utilized efficiently.

The computer, method for managing the storage area of the computer, and computer system according to the present invention were described hereinabove but the embodiments of the present invention are for the purpose of simplifying an understanding of the present invention and do not limit the present invention. The present invention can be modified or improved without departing from the meaning or scope of the claims and equivalent embodiments are naturally included in the present invention.

For example, in the first embodiment, the resource groups and volume assignment policy are associated and, at the time of a volume assignment request, a physical area is determined in accordance with the volume assignment policy associated with the resource group by designating a resource group to which the volume belongs. However, the present invention is not limited to the above arrangement. Management may also be carried out by associating life cycle definitions directly with the respective volumes, for example. In this case, when a volume is assigned, the life cycle of the volume is set.

Furthermore, according to the first embodiment above, when a volume is assigned, a designation of the business to which the volume belongs is accepted from the user. However, the backup start time of the volume may also be accepted, for example. In this case, the resource group management table T12 shown in FIG. 5 may be provided and there is no longer any need to perform the processing of step S2002 in the volume assignment processing shown in FIG. 9.

Furthermore, in the second embodiment, a life cycle name field is not provided in the resource group management table T52 but the present invention is not limited to such a resource group management table T52. A life cycle name field may also be provided and the life cycle definition name that is utilized by default may be stored in the field. Furthermore, given that an access frequency history that is adequate for specifying the access frequency trend of each group is not stored in the access frequency history table T53, for example, in cases where the life cycle of a group cannot be determined, the physical area of the volume may also be determined on the basis of the life cycle definition that corresponds with the life cycle definition name stored in this field.

Furthermore, although the volume assignment policy table T51 is provided in the second embodiment, the volume assignment policy table T51 need not be provided. In this case, the CPU 11 detects the expected access frequency reduction time of each RAID group from the access frequency history for each volume in the RAID group. More specifically, the CPU 11 executes the same processing as steps S4003 and S4007 for the volumes in the resource group to which each volume belongs with respect to each of the volumes belonging to the RAID group and, after determining the period Ta until the access frequency of the volume belonging to the RAID group drops, the CPU 11 determines a time Tb during which period Ta has elapsed after the volume was assigned. Thus, the latest time Tb within the time Tb determined for all of the volumes in the same RAID group is regarded as the expected access frequency reduction time of the RAID group. Furthermore, the CPU 11 detects the expected access frequency reduction time for a plurality of RAID groups and uses the detected time to execute the processing of step S4013. As a result, as per the second embodiment, volumes assumed to have matching access frequency reduction times can be assigned from the same RAID group and the power saving function of the disk device 24 provided by the storage system 20 can be made to operate effectively.

Furthermore, in the case of the first and second embodiments, in the volume assignment processing described above, when volume assignment processing for the secondary volume of the copy pair is carried out after assigning the primary volume of the copy pair that is utilized in the business, information obtained in the steps of the processing of the primary volume may also be utilized to perform the volume assignment processing for the secondary volume. For example, in the processing shown in FIG. 17, the expected access reduction time obtained in step S4009 is prepared in the processing for the primary volume and, by utilizing the expected access reduction time, there is no need to execute the steps of the steps S4003 to S4009 in the volume assignment processing for the secondary volume and the volume assignment can be executed rapidly.

What is claimed is:

1. A volume assignment management device for determining, as an assignment source of a logical volume that is assigned in order to store predetermined data, a physical area including one or more storage media among a plurality of storage media provided in a storage system, comprising:
a request acceptance unit that accepts an assignment request for the logical volume; and
a physical area determination unit which, in cases where the assignment request for the logical volume is accepted, determines the physical area which is the assignment source of the logical volume on the basis of an access trend assumed for the logical volume which is a subject of the assignment request.

2. The volume assignment management device according to claim 1, further comprising an assignment policy storage unit that associates and stores information for specifying the access trend and identification information for the physical area that is to constitute the assignment source for the logical volume for which the access trend is assumed, wherein
the request acceptance unit accepts information for specifying the access trend assumed for the logical volume which is the subject of the assignment request as the assignment request for the logical volume, and
the physical area determination unit acquires identification information for the physical area corresponding with the information specifying the access trend accepted by the request acceptance unit and determines the physical area indicated by the identification information as the assignment source of the logical volume which is the subject of the assignment request.

3. The volume assignment management device according to claim 2, further comprising:
a policy acceptance unit that accepts information specifying a certain access trend that is to be registered in the policy storage unit; and
a policy storage unit which, incases where an identification area of a physical area that corresponds with the information specifying the certain access trend has not been associated with in the policy storage unit, associates and stores the information specifying the certain access trend and an identification information of a physical area that corresponds with information specifying an access trend analogous to the certain access trend in the policy storage unit.

4. The volume assignment management device according to claim 1, wherein the access trend includes a trend for the access time of the logical volume.

5. The volume assignment management device according to claim 4, wherein the trend for the access time is a start time for a backup that uses the logical volume.

6. The volume assignment management device according to claim 1, wherein the access trend includes a trend for an access frequency reduction time of the logical volume.

7. The volume assignment management device according to claim 1, further comprising a frequency history storage unit that stores correspondence between a group name that indicates a group of logical volumes having the same access frequency reduction trend and the access frequency history of the logical volumes that belong to the group, wherein
the request acceptance unit accepts the group name of the group to which the logical volume which is the subject of the assignment request belongs as the assignment request of the logical volume,
the volume assignment management device further comprises:
a first reduction period detection unit that detects a first reduction period for the access frequency of the logical volume belonging to the group indicated by the accepted group name on the basis of the access frequency history; and
a first reduction time determination unit that determines a first expected reduction time for the access frequency of the logical volume which is the subject of the assignment request on the basis of the first reduction period, and wherein
the physical area determination unit determines the physical area constituting the assignment source of the logical volume which is the subject of the assignment request on the basis of the first expected reduction time.

8. The volume assignment management device according to claim 7, further comprising:
a physical area correspondence storage unit that stores correspondence between the access frequency history of the logical volumes belonging to the group indicated by the group name and the physical areas for storing the logical volumes;
a second reduction period detection unit that detects a second reduction period for the access frequencies of the logical volumes belonging to the groups indicated by all the group names of the frequency history storage unit on the basis of the access frequency history; and
a second reduction time detection unit that detects a second expected reduction time for the access frequency for each physical area on the basis of the detected second reduction period, wherein
the physical area determination unit determines, as the assignment source for the logical volume which is the subject of the assignment, a physical area of which the second expected reduction time matches or is close to the first expected reduction time for the access frequency of the logical volume which is subject of the assignment.

9. The volume assignment management device according to claim 7, wherein the group is a group of logical volumes, the units of which are businesses.

10. The volume assignment management device according to claim 7, wherein the access frequency history is a history of information that indicates whether the access frequency is an access frequency at which the power saving function for the physical area is executed.

11. The volume assignment management device according to claim 1, wherein the physical area is a storage area of two or more of the storage media that constitute the same RAID group.

12. The volume assignment management device according to claim 1, further comprising an assignment instruction transmission unit that transmits, to the storage system, an instruction to set the logical volume which is the subject of the assignment request in the determined physical area.

13. The volume assignment management device according to claim 1, wherein the storage system executes the power saving function for the storage media in accordance with an access status of the storage media.

14. A volume assignment management method of a volume assignment management device that determines, as an assignment source for a logical volume that is assigned in order to store predetermined data, a physical area containing one or more storage media among a plurality of storage media provided in the storage system,
the method comprising the steps of:
accepting an assignment request for the logical volume; and
determining the physical area constituting the assignment source of the logical volume on the basis of the access trend assumed for the logical volume which is the subject of the assignment request in cases where the logical volume assignment request is accepted.

15. A volume assignment management program stored in a computer-readable medium, the program being capable of causing a computer to determine, as an assignment source for a logical volume that is assigned in order to store predetermined data, a physical area containing one or more storage media among a plurality of storage media provided in a storage system,
the program further being capable of causing the computer to carry out as:
a request acceptance unit that accepts an assignment request for the logical volume; and
a physical area determination unit that determines the physical area which is the assignment source of the logical volume on the basis of an access trend that is assumed for the logical volume which is the subject of the assignment request in cases where an assignment request for the logical volume is accepted.
